(19) United States
(12) Patent Application Publication
(10) Pub. No.: US 2014/0222448 A1
(43) Pub. Date: Aug. 7, 2014

(54) DRUG LABELING TOOL

(71) Applicants: Christine P. Janson, Dedham, MA (US); Ethan B. Jacoby, Wellesley Hills, MA (US); Jeffrey Cooper, Belmont, MA (US)

(72) Inventors: Christine P. Janson, Dedham, MA (US); Ethan B. Jacoby, Wellesley Hills, MA (US); Jeffrey Cooper, Belmont, MA (US)

(73) Assignee: Biogen Idec MA Inc., Cambridge, MA (US)

(21) Appl. No.: 14/128,790

(22) PCT Filed: Jun. 29, 2012
(86) PCT No.: PCT/US12/44902

§ 371 Date: Mar. 27, 2014

Related U.S. Application Data
(60) Provisional application No. 61/504,079, filed on Jul. 1, 2011.

(51) Int. Cl. G06Q 50/22; G06F 3/0482; G06Q 30/00

(52) U.S. Cl. CPC G06Q 50/22; G06Q 30/018; G06F 3/0482
USPC 705/2; 715/780

(57) ABSTRACT

A tool for aiding a user author labels for drugs. The tool receives inputs that define requirements for a label, or aggregated requirements for a set of related labels. The requirements may be derived from inputs specifying values of label attributes and then be used to identify fields to appear in each of one or more labels to be generated. Information on fields may be used to dynamically render an interface through which a user may specify text strings to appear in each field when label text is generated. Input elements of the interface may be populated with lists of options identified based on the requirements. The requirements may also be used in generating similar labels and assessing the impact of changes, such as to regulatory requirements. The tool may be particularly useful for authoring labels for clinical trials in which multiple label formats for multiple countries may be generated.

### BACKGROUND

1. Field of the Invention

Some embodiments of the invention relate generally to labeling of drugs and more specifically to a computerized tool, which may be particularly well suited for use in conducting a clinical trial, for generating drug labels.

2. Description of the Related Art

Drugs administered in clinical trials are subject to labeling requirements that can vary among different regulatory regions (e.g., countries). Generating and maintaining labels for a clinical trial can be burdensome for a drug company or other entity conducting a clinical trial. Different labeling may be required for drugs being administered in different protocols. Yet, there may be multiple protocols in a single clinical trial. Further, when clinical trials are conducted in multiple countries, different labeling may be required in each country. Further compounding the burden, different labeling may be required for different package styles.

A conventional method for authoring labels requires an author to (1) define the label's text based on the country-specific regulatory requirements, (2) translate the text into languages as required for the countries in which the drug is to be distributed, and (3) assemble the label pages into a booklet with an index page. If companion labels in other formats are required or other labels are required, further effort may be required.

### SUMMARY

In some aspects, the invention relates to a method of generating a label for a drug. The method may include receiving user inputs identifying a plurality of label attributes. Based on the plurality of label attributes, a plurality of label fields may be determined. An interface may be rendered on a display device based on the determined plurality of fields. The interface may contain a plurality of input area, each corresponding to a respective label field of the plurality of label fields. User inputs may be received through the plurality of input areas to specify a text string associated with a respective label field of the plurality of label fields. Label text may be automatically generated based on the received user input specifying text strings.

In another aspect, the invention relates to a computer-readable storage medium comprising computer-executable instructions, that, when executed by a computing system, perform a method of generating a label for a drug. That method may entail receiving user input indicating values of a plurality of label attributes and receiving user input indicating a plurality of regulatory domains. Based on the values of the plurality of label attributes, a set of label fields representing an aggregation of label fields applicable in the plurality of regulatory domains may then be determined. A user interface adapted to receive a respective value for each label field in the set may be generated and a label may be generated based on values received through that user interface.

In another aspect, the invention may relate to a system for generating a label for a drug for a clinical trial protocol. The system may include a user interface device and a processor. The processor may be configured to receive user inputs identifying values of a plurality of label attributes. Based on the plurality of label attributes, the processor may determine a plurality of label fields and render on the user interface device an interface based on the determined plurality of fields. Such an interface may be adapted to receive a plurality of values, each value corresponding to a respective label field of the plurality of label fields. Additionally, the processor may generate label text based on the received plurality of values.

Yet a further aspect may relate to a computerized method of operating a labeling tool. The method may include receiving user input identifying values of a plurality of label attributes. Based on the values of the plurality of label attributes and first stored information, a first plurality of label requirements may be determined. A label based on the first plurality of label requirements may be generated and the first plurality of label requirements may be stored. At a second time, a second plurality of label requirements may be determined based on the values of the plurality of label attributes and second stored information. The first plurality of label requirements may be compared to the second plurality of label requirements with at least one processor. Differences identified by such a comparison may be presented through a user interface.

The foregoing is a non-limiting summary of the invention, which is defined by the attached claims.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a sketch of a computerized system for generating labels;

FIG. 2 is a flowchart of a method of operating a system for generating labels;

FIGS. 3A and 3B, when connected at the points labeled “B,” are a graphical representation of a taxonomy of label attributes that may be used by a system for generating labels;

FIG. 4 is a sketch of a graphical user interface that may be rendered by a computerized system for generating labels to acquire label attributes;

FIG. 5 is a sketch of a spreadsheet that may be used to store information used by a system for generating labels to identify fields appearing in a label based on label attributes specified by a user;

FIG. 6A is a sketch of a graphical user interface that may be rendered by a computerized system for generating labels to acquire values for label fields;

FIG. 6B is an alternative view of the graphical user interface of FIG. 6A, illustrated in a configuration in which a user has scrolled to reveal alternative portions of the graphical user interface;

FIG. 7 is a sketch of a spreadsheet of phrases that may appear in fields of a label and may be used by a computerized label generation system;

FIGS. 8A and 8B are sketches of labels that may be generated by a system for generating labels;

FIG. 9 is a flowchart of an exemplary implementation of sub-process 290 (FIG. 2);

FIG. 10 is a flowchart of a method for processing user input specifying requirements for a label for which requirements have been previously specified;

FIG. 11 is a sketch of a graphical user interface that may be generated by a computerized system for generating labels while executing the process illustrated in FIG. 10;

FIG. 12 is a block diagram of an exemplary computer system that may be programmed to implement a computerized system for generating labels; and

FIGS. 13A and 13B are sketches of graphical user interfaces through which an administrator may enter data to configure a computerized system for generating labels based on regulatory requirements.

### DETAILED DESCRIPTION

The inventors have recognized and appreciated that conventional methods of labeling a drug are time-consuming, tedious, and error-prone. This problem is particularly acute for a clinical trial in which labeling may be generated for each of multiple protocols that may be followed as part of the clinical trial, which may be conducted in multiple countries, which each may have a different set of regulations. Changes to the relevant protocol, method or location of administration, or container size may necessitate changes to the content of the labels, further exacerbating the problem. Likewise, changes to a single country's regulations may (1) necessitate changes to the contents of labels for drugs used in clinical trials in that country, (2) necessitate authoring of new labels for countries that previously shared a label with that country, or (3) present new opportunities for combining that country's label with the labels of other countries.

The inventors have further recognized and appreciated that improvements may be achieved by a computerized tool that can aid a user in generating and maintaining labels. The tool may operate by identifying label requirements. These requirements, for example, may be defined in terms of fields to be included in a label. In scenarios in which labels are to be generated in multiple styles or for multiple countries, the requirements may represent the aggregate of all fields for all labels to be generated.

In some embodiments, the fields to be included in each label may be identified based on values for label attributes input to the tool. The tool may be configured with a data store containing information relating sets of attribute values to label requirements. Such relationships may be defined for each regulatory domain in which a label may be required, allowing label requirements for all relevant regulatory domains to be identified.

Other configuration information may aid in identifying label requirements. The system, for example, may be programmed with rules defining which countries can share a common label in one or more languages. Additionally, the system may be configured with templates in multiple formats. An appropriate template may be selected based on a label style and/or values of other label attributes.

The tool may use information input into the system in combination with configuration information programmed into the system to identify label requirements. These label requirements in turn may be used to identify fields to be included in one or more labels to be generated. Specific values to populate these fields than may be obtained from a user. In some embodiments, the tool may use the identified requirements to determine which values to request a user to provide. To aid in collecting user input, a user interface may be dynamically constructed, including input elements associated with each of the fields for which user input is solicited.

In some embodiments, the input elements making up the user interface may offer a user a constrained set of choices for each of the fields. The set of choices may be based on configuration information stored in the system. This configuration information may represent options for text to appear in each possible field that the system is configured to recognize. In this way, regardless of the set of requirements for any given label, a set of possible text strings to occupy each field may be identified and presented to a user to select a specific text string to appear as part of the label. In addition, appropriate translations of each text string may be available such that a corresponding version of the label may be generated for each of multiple languages.

Generated labels may be stored as complete labels, including text. Alternatively or additionally, generated labels may be stored as a set of requirements. These requirements may define fields to appear in a label. Storing the labels as a set of requirements, either with or without associated text strings, may facilitate maintaining a set of labels. For example, the set of requirements may be accessed to generate a label for a further regulatory domain or in another language as part of a set of labels for a drug in a clinical trial.

Moreover, having access to requirement information may help a user assess the impact on labeling of a regulatory change or other event that may change labeling requirements. Rather than comparing text of new and existing labels to assess the impact of changes, requirements used in generating an existing label may be compared to new requirements. Differences in requirements may be presented to a user. Presenting differences in this fashion may be more intuitive for a user to understand, leading to more rapid identification of the significance of a change. With this information, a user may better assess whether to continue using existing labels or produce and deploy new ones.

Moreover, when a new label is generated, inputs defining label attributes, text strings to appear in required fields and other parameters that are likely to be the same as for an existing label may be leveraged. For example, when a new label is to be designed, a user may specify that the tool load selections made by a user while authoring a similar label. These inputs may populate selections, which may be presented to a user through a graphical user interface that allows the user to modify the selections. Prior selections may become default selections for authoring the new label. As a specific example of this capability, in authoring a label for a country that did not previously participate in a clinical trial, the user may reload inputs specified while authoring a label for another country with clinical trial sites already participating in the same clinical trial. The user may then modify the country selection input, leaving all other inputs in the pre-loaded state, and then generate labels for the new country.

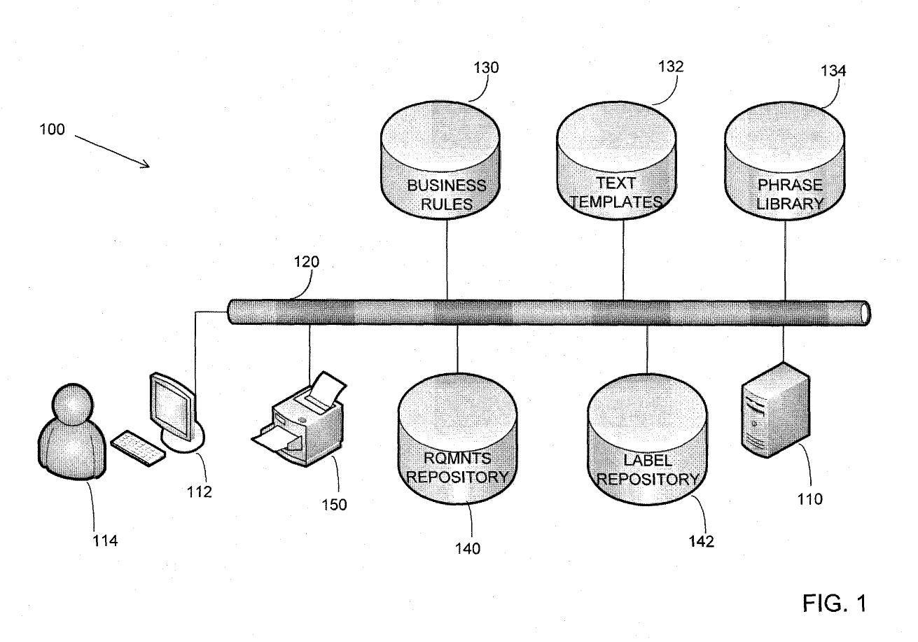

A tool as described herein may be implemented in any suitable computerized system. Turning to FIG. 1, an exemplary system 100 is illustrated. System 100 may be operated to assist a user 114 generate labels for drugs. The drugs may be of an suitable type, including small molecule drugs, therapeutic proteins or other pharmaceutical compounds. In the embodiment illustrated, system 100 is configured to generate labels for drugs that are distributed as part of a clinical trial. However, it should be appreciated that the invention is not limited to generating labels for clinical trials. Embodiments may be constructed for any suitable scenario in which labels are to be generated.

In the example of FIG. 1, the system include a computing device 110 that is programmed with a label generation tool. A user 114 may accesses computing device 110, and the tool, through a user work station 112. Work station 112 may be a personal computer, such as a desktop or portable computer. Though, the specific hardware components used to access system 100 are not critical to the invention.

The user work station 112 may be coupled to computing device 110 over a network 120. In this example, network 120 may be an enterprise network within a drug company that has developed a drug to be tested as part of a clinical trial. However, the specific entity that maintains and/or operates system 100 is not critical to the invention. System 100, for example, may be operated by a third party service provider that prepares labels for drugs undergoing clinical trial. Moreover, it is not a requirement that all of the components of system 100 be located within a single entity. For example, network 120 may be or include a public network, such as the Internet, through which components in other locations or operated by other entities may form a portion of the system.

In the example of FIG. 1, printer 150 is shown connected to network 120. Printer 150 may be used to print labels in a format generated by a tool executing on computing device 110. Accordingly, printer 150 may be located in a manufacturing facility of a drug company operating system 100. Alternatively, printer 150 may be operated by a company hired by a drug company to print labels for a clinical trial.

System 100 is shown to contain multiple data stores containing information that may be input or output by system 100 or used in the generation of labels, which may similarly be stored on any suitable hardware components in any suitable location. One or more such data stores may store information characterizing labels generated by system 100. In this example, data store 140 is shown to hold requirements for a label that are generated by operation of the tool. Data store 142 is illustrated as holding a repository for label text that may be generated. Data stores 140 and 142 may be stored in any suitable components, in any suitable location, managed by any suitable entity. In some embodiments, both data stores 140 and 142 may be stored in a conventional storage system coupled to network 120. Though, in some embodiments, either or both of data stores 140 and 142 may be maintained by a separate entity. For example, data store 142, holding text to be printed on labels, may be maintained by a printing company. Further, it is not a requirement that each of the data stores be maintained in a hardware component separate from computing device 110. In some embodiments, some or all of the data stores may be stored in computer storage media internal to computing device 110.

Likewise, data stores, such as data stores 130, 132 and 134, storing information accessed by system 100 in generating label requirements or label text may be stored on any suitable components, in any suitable location and managed by any suitable entity. In this example, data store 130 contain rules that relate user inputs to label requirements. In the illustrated example, data store 130 contains business rules indicating countries for which label text may be presented on the same label panel. For example, when user 114 provides input to system 100 requesting generation of a label for a drug to be distributed in the United States and Canada, information stored in data store 130 may indicate whether a single label panel can be used to present text required to meet regulatory requirements in both the U.S. and Canada or whether two separate label panels are required. As another example, France and Switzerland may both require labeling in German and may accept the same label in German. Germany, however, may require labels in a different dialect than either France or Switzerland such that the German text used for France and Switzerland cannot be used in Germany.

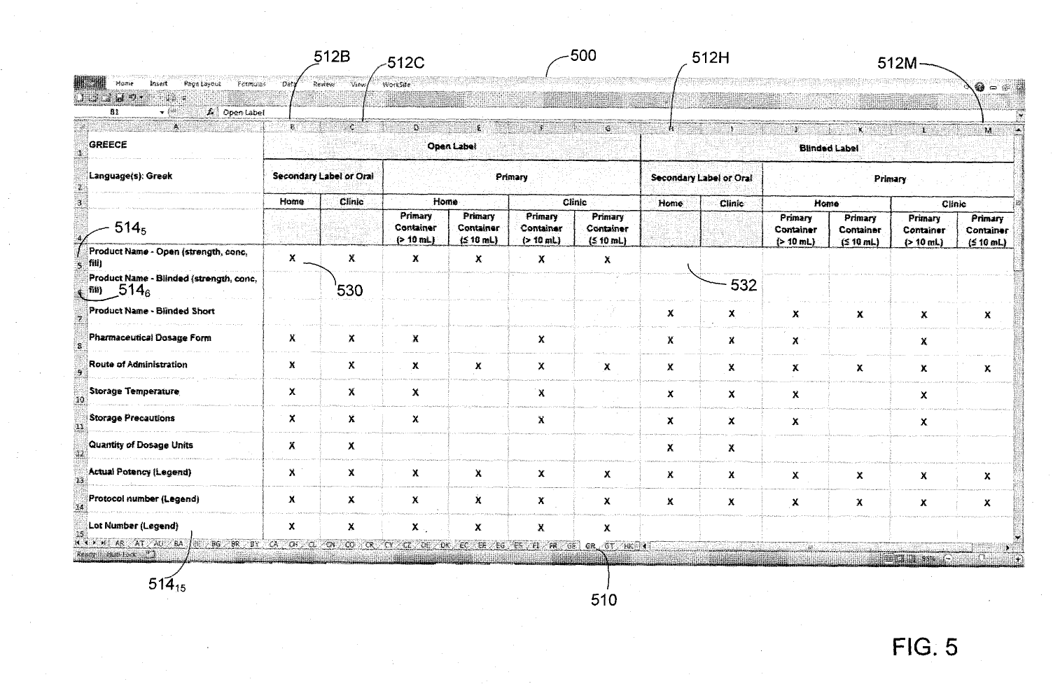

Additionally, information in data store 130 may indicate for different types of labels what fields are to appear on the label. The label types may be characterized by different combinations of values of label attributes. An example of information of this type is provided in FIG. 5, which is discussed in detail below.

System 100 may include other storage for information used by system 100 for use in generating a label. For example, data store 132 may contain text templates defining how text is to be laid out when generating a label. Different templates may be provided for different label types or label styles. Phrases that may be selected by a user to appear on a label may similarly be stored. Data store 134 may contain text phrases that may appear on labels generated by a tool. For each phrase in a primary language of the system, corresponding phases in one or more other languages may also be stored. The information in data stores 130, 132 and 134 may be obtained from any suitable sources. For example, business rules and translations may be obtained from regulatory experts in each of multiple countries. This information may be gathered in advance of using the tool. Alternatively or additionally, the information may be updated as the tool is used, reflecting changes in regulatory requirements or information developed as new labeling needs are encountered.

In operation, a tool executing on computing device 110 may be configured to receive user input and access data stores, such as data stores 130, 132 and 134, to determine requirements for a label. The tool may be further configured to determine, based on user input and information in data stores 130, 132 and 134, text strings meeting requirements for a particular label.

The tool may be further programmed to generate a label. Any suitable format of the output may be used to characterize a generated label. In some embodiments, the generated label may be represented by the requirements for the label. The requirements, for example, may be expressed as a set of fields to appear on the label. The identified requirements may be stored, for example, in data store 140.

Alternatively or additionally, the output may be represented as label text, containing appropriate text strings in appropriate fields to meet the identified requirements. A label, laid out in the appropriate format with the appropriate text strings, may be stored in data store 142. This information may then be used to print labels to attach to packaging for pharmaceuticals to be distributed for use in a clinical trial.

For simplicity, system 100 was described as generating a single label for a single drug to be distributed as part of a single clinical trial. However, it should be appreciated that a clinical trial may be conducted in multiple different countries or other regulatory domains. Different label requirements may apply in different regulatory domains. System 100, therefore, may store data useful in generating appropriate labels in each regulatory domain in which a clinical trial may be conducted. The system may generate and store labels generated for each such regulatory domain either individually or simultaneously. Labels for different regulatory domains may be used in any suitable way. In some embodiments, labels for different regulatory domains may be combined into a booklet format, with multiple panels. Label information for a regulatory domain may occupy each panel. Though, for simplicity, any form of output may be regarded as a “label.”

Moreover, it should be appreciated that a clinical trial may entail administering drugs in accordance with different protocols, which may differ according to dosage schedule, amounts or other parameters. Different labels may be generated for different protocols within the same clinical trial. Accordingly, it should be appreciated that the same system may be configured with information to generate labels for multiple protocols. Further, it should be appreciated that system 100 may be used to generate labels for multiple drugs or for multiple clinical trials involving the same drug.

Accordingly, data store 140 containing label requirements may store requirements for multiple labels. Likewise, data store 142, storing label text, may store text for labels associated with multiple drugs or for use in connection with multiple labels. Similarly, the data stores containing information used in generating labels may store information for multiple drugs or for multiple protocols and/or multiple regulatory domains.

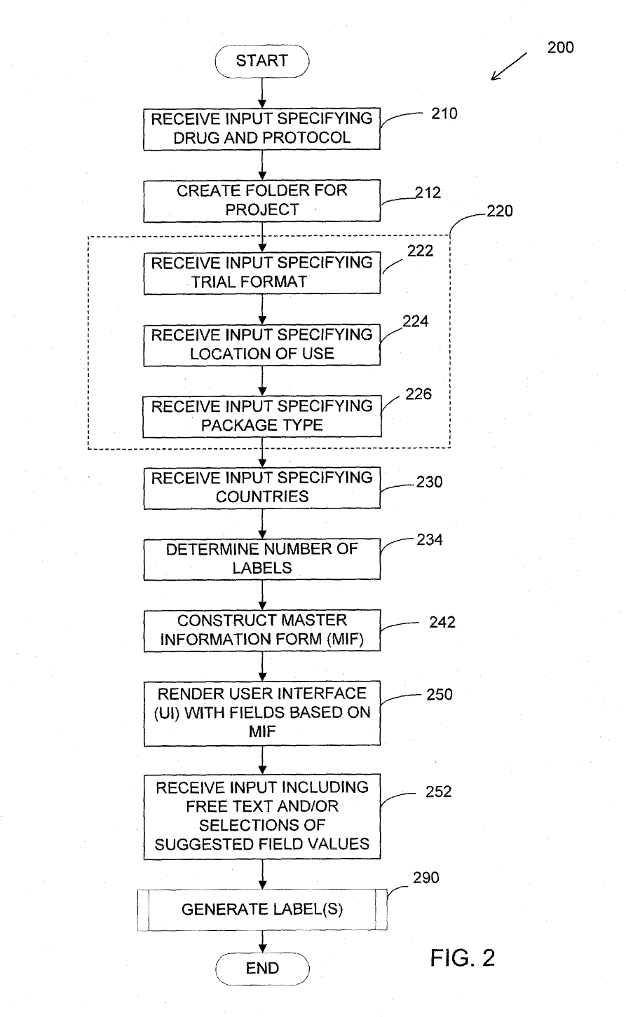

FIG. 2 illustrates a method 200 that may be performed by a tool that may execute on a computing device, such as computing device 110 (FIG. 1) as part of a system for generating labels for drugs that may be distributed as part of a clinical trial. The tool may be constructed using programming techniques as are known in the art to control a computing device to perform some or all of the functions described herein. Execution of such a tool may be initiated by a user, such as user 114 (FIG. 1), who supplies inputs related to the drug and/or clinical trial. Though, it should be appreciated that it is not a requirement that inputs used by the tool be supplied by a user. The inputs, for example, may be obtained from a computerized system or other suitable source, such as another computer system.

Regardless of how the method is initiated, method 200, in this example, begins at block 210. At block 210, the system may receive input identifying the label to be generated. For example, the label may be identified by specifying a drug and a protocol to be followed in a clinical trial involving the drug. This information may allow a user at a later time to access information provided for generation of a label. Such later access may allow a user to provide inputs in multiple sessions, whenever convenient for the user. Moreover, access at a later time may allow a user to generate new labels based on stored information.

At block 212, the system may create one or more data structures for organizing information relating to the label or labels to be generated. In the illustrated example, information relating to a particular label to be generated is organized in a folder such as may be provided by an operating system of a computing device, as is known in the art. Such a folder may store inputs provided by the user. Additionally, such a folder may store outputs generated by the tool. Those outputs, for example, may include requirements, such as are shown in data store 140 (FIG. 1) and/or formatted label text such as is shown stored in data store 142 (FIG. 1). Further, such a folder may capture version information, indicating the version of rules or other configuration information in use when label requirements were determined. However, it should be appreciated that creating a folder is just one example of a mechanism by which information relating to the generation of a label may be organized.

Regardless of the manner in which the information relating to inputs and/or outputs related to a label are stored, method 200 may proceed to sub-part 220 where values for attributes characterizing the label may be input. Values of these attributes may be used to determine requirements for a label. Values of any suitable attributes may be obtained. At block 222, for example, the tool may receive input specifying a trial format. At block 224, the tool may receive input specifying the location of use of the pharmaceutical. At block 226, the tool may receive input specifying a package type.

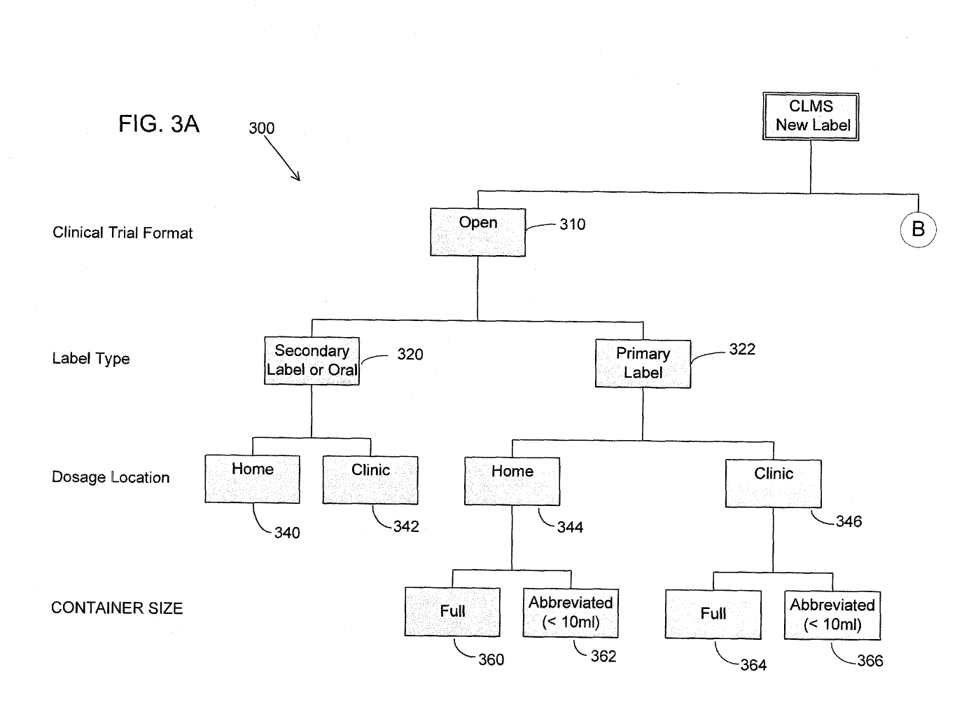

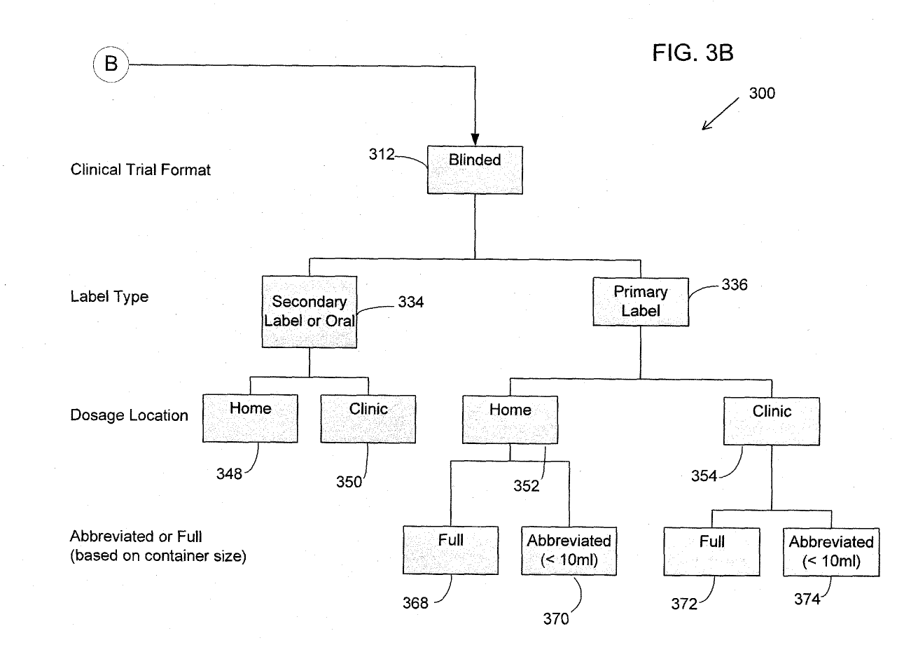

However, it should be appreciated that the values for attributes received at blocks 222, 224 and 226 are illustrative of a set of attributes that may be used to determine label requirements. Another example is provided in FIGS. 3A and 3B. FIGS. 3A and 3B, when connected at the point labeled “B,” define a taxonomy of attribute combinations that may be used to characterize labels for which the tool may generate a label. Each of the terminal nodes in the taxonomy 300 is associated with a different set of label requirements such that each terminal node may characterize a type of label.

In this example, taxonomy 300 is hierarchical, with each layer in the hierarchy corresponding to a label attribute about which a user may provide input. The first layer in the hierarchy corresponds to the clinical trial format. In this example, the clinical trial format attribute may take on a value of “open” or “blinded.” Accordingly, user input may distinguish between node 310, associated with an open clinical trial format and node 312, associated with a blinded clinical trial format. In this example, the terms “open” and “blinded” have a meaning as is known in the art. A value of “open” may indicate that a patient and/or health care provider administering study drugs knows the type, amount or other characteristics of a drug being administered. In contrast, in a “blinded” clinical trial, neither the patient nor health care provider knows the characteristics of the drug administered to each patient. Accordingly, labels generated for open versus blinded studies may have different requirements.

The second layer of taxonomy 300 indicates the label type. In the embodiment illustrated, a label may be either a primary label or a secondary label. These terms also may have a meaning as are known in the art, such that a primary label is affixed to the packaging of the drug to be distributed for a clinical trial. The secondary label may be distributed, in some way, in connection with the drug, but need not be directly affixed to the packaging for the drug. A secondary label, for example, may be inserted in a package for a drug or may be provided for a health care provider to read to a patient receiving the drug. A label may have different requirements depending on whether it is to be used as a primary or secondary label.

The taxonomy illustrated in FIGS. 3A and 3B indicates that a label may be either primary or secondary and that each of these types may exist for either an open or blinded trial. Accordingly, four nodes are shown in the second layer of taxonomy 300. Node 320 corresponds to a secondary label in an open trial. Node 322 corresponds to a primary label in an open trial. Node 334 corresponds to a secondary label in a blinded trial, and node 336 corresponds to a primary label in a blinded trial.

A third layer of taxonomy 300 corresponds to dosage location. In this example, the dosage location attribute may have values of either “home” or “clinic.” These values may also have meaning as are known in the art. The value “home” may indicate that a patient in a clinic trial is given the study drug to take at home. A value of “clinic” may indicate that a patient in a clinical trial is given the study drug in a hospital, doctor's office or other “clinic” setting. Different label requirements may apply, depending on whether the drug is to be administered in a home or clinic setting.

In the example illustrated, a tool configured to generate labels according to taxonomy 300 may recognize different label requirements for labels for home or clinic use, regardless of whether the label is intended as a primary or secondary label and regardless of whether the drug is to be administered as part of an open or blinded trial. Accordingly, taxonomy 300 includes in the third layer eight nodes. Node 340 indicates a secondary label to be prepared for home administration in an open clinical trial. Node 342 indicates a secondary label to be prepared for clinic administration in an open clinical trial. Node 344 indicates a primary label prepared for home administration in an open clinical trial. Node 346 indicates a primary label prepared for clinical administration in an open clinical trial. Nodes 348, 350, 352 and 354 correspond to secondary and primary labeling in a blinded clinical trial for home or clinic administration.

In this example, nodes 340, 342, 348 and 350 are terminal nodes in taxonomy 300. Accordingly, the tool accessing taxonomy 300 may be configured to generate a label of a type corresponding to each of these nodes.

In contrast, nodes 344, 346, 352 and 354 are connected to nodes in a fourth layer of the taxonomy. In this example, the fourth layer of the taxonomy corresponds to a label attribute indicating container size. The size of the container may indicate the size of the label, which may further be relevant for determining the amount of information that may be displayed on the label. In this example, containers below some threshold size, here indicated as 10 ml, are provided with abbreviated labels. Containers above the threshold size may be provided with a full label. Accordingly, the container size attribute may take on values indicating either full or abbreviated.

In this example, taxonomy 300 contains only four layers. Accordingly, each of the nodes in the fourth layer is a terminal node, representing a combination of label attributes for which the tool may be configured to determine label requirements. In this example, node 360 indicates a full primary label prepared for a drug for home administration in an open protocol. Node 362 represents an abbreviated primary label prepared for a drug for home administration in an open trial. Node 364 corresponds to a full primary label prepared for a drug for clinic administration in an open trial. Node 366 represents an abbreviated primary label prepared for a drug for clinic administration in an open clinical trial. Node 368 corresponds to a primary label prepared for a drug for home administration in a blinded clinical trial. Node 370 corresponds to an abbreviated primary label prepared for a drug for home administration in a blinded clinical trial. Node 372 corresponds to a full primary label prepared for a drug for clinic administration in a blinded clinical trial. Node 374 corresponds to an abbreviated primary label prepared for a drug for clinic administration in a blinded clinical trial. A tool may be configured to determine label requirements for labels corresponding to each of these terminal nodes such that input specifying values for the label attributes corresponding to each label in the hierarchy can be used by the tool to identify requirements for a label being generated. The taxonomy of FIGS. 3A and 3B may be desirable for use in determining a label type because the type can be determined from a limited number of label attributes and a limited number of possible values for each attribute. Accordingly, a system may be readily configured with label requirements related to each label type as defined by terminal nodes of the taxonomy. Though, it should be appreciated that any suitable taxonomy or other method to classify labels may be used.

Additional information may also be used to determine label requirements. In some embodiments, the specific requirements for a label, even when values for label attributes are specified, may further depend on the country or other regulatory domain in which the label is to be used. Accordingly, method 200 (FIG. 2) may include a block 230 at which input specifying one or more regulatory domains for which labels are to be generated may be received. In this example, the regulatory domains are specified by identifying specific countries. Based on the values for the label attributes and the countries specified, the tool may determine requirements for one or more labels to be generated.

Accordingly, method 200 proceeds to block 234 where the tool determines a number of labels to be generated. Though one approach may be to generate a label for each regulatory domain specified at block 230, some label formats may be suitable for use in multiple regulatory domains. In scenarios in which user input indicates labels for multiple regulatory domains are required, a tool executing method 200 may access information indicating whether the same label format may be used in multiple regulatory domains for which a label is requested. When the method 200 is implemented by a system such as system 100 (FIG. 1), the information used at block 234 may be accessed from business rules data store 130 or a similar data store. Though, it should be appreciated that any suitable mechanism may used to determine the number of different label formats required to supply a label for each of the specified regulatory domains. Conversely, some regulatory domains may require labels in multiple languages. These requirements may also be determined from information in data store 130 or other suitable sources.

Once the number of labels to be generated, and the applicable language and/or regulatory domain for each label, is determined, the method may proceed to block 242. At block 242, a master information form may be generated. The master information form may contain the aggregate label requirements for all of the labels to be generated. In the embodiment illustrated, label requirements may be expressed as fields to appear in a label. Though, other information alternatively or additionally may be used to express label requirements.

These fields, for example, may be associated with items that may appear on a label for a drug. For example, a field may be defined to hold a text string indicating dosage frequency or dosage amount for a drug. Other fields may hold other types of information. For example, fields may be defined to hold information about storage or handling of a drug, route of administration or other information that may appear on a drug label. The information in the master information form may be aggregated in the sense that if the same field appears in labels for multiple regulatory domains, the requirement for that field may appear only once in the master information form. Though, the master information form may be formatted in any other suitable way that allows the tool to recognize duplicated fields.

Formatting label requirements in this way allows the tool to obtain input once for a field and use it for multiple labels that may include a field of that type. As a specific example, labels that are prepared in different languages may nonetheless have fields of the same type—though when the fields are populated with text strings, a string in different languages may be inserted into the same type of field in different labels. Accordingly, it should be appreciated that field type may be determined independently of the text strings that will populate a field of that type when label text is generated.

In some embodiments, labels generated for different regulatory domains may contain text in different languages, with the text of each label appearing in the predetermined language of the regulatory domain in which the label is to be used. However, in the embodiment illustrated, the master information form stores label requirements in terms of fields rather than specific text of the labels. Information about the text to be populated in each field upon generation of a label may be obtained in subsequent steps of method 200. At block 250, the tool executing method 200 may prompt a user to select text strings to be populated in each field identified in the master information form. In the embodiment illustrated, this prompting may be through an interface rendered on a display device of a computer system. Accordingly, the tool may construct a user interface with an input area corresponding to each field identified in the master information form.

At block 252, the tool may receive input indicating text to be inserted in the fields identified in the master information form. The inputs received at block 252 may be received through the rendered interface or in any other suitable way. In some scenarios, the input may be received as free form text input. In other scenarios, and for other fields, input may be received though an input element that supports a selection from among a specified set of choices. These choices, for example, may be specified by enumerating them such that the input may be in the form of an indication of an enumerated choice.

In the embodiment illustrated, the tool receives text inputs at block 252 in a primary language of the tool, even if labels in other languages are to be generated. In the examples provided herein, the primary language of the tool is English. To generate labels in another language, the tool may automatically translate text strings selected in the primary language to a language as appropriate for the regulatory domain for which a label is to be generated.

In some embodiments, the inputs received at block 252 may be selected from a set of phrases stored in phrase library 134. In conjunction with phrases in the primary language of the system stored in phrase library 134, a translation of each phrase may also be stored. In this way, a tool executing method 200 may have access to text, in any language supported by the tool, to fill in any field of a form being generated. Though, it should be appreciated that text strings representing values to be populated in fields to generate the text for a form may be obtained in any suitable way.

Once the inputs defining a label are received, method 200 may proceed to sub-process 290 at which one or more labels may be generated. The labels may be generated in any suitable format. In some scenarios, generating a label may entail generating text for each field in the label. The fields on the label may be formatted based on the values for the label attributes received in subpart 220. The formatting may be determined based on a template, such as may be stored in text template data store 132, or in any other suitable way. Though, a label may be generated by storing information that fully or partially characterizes the label. For example, generation of a label may entail storing the label requirements for the label. The requirements may be represented by information in the master information form, such as required fields. The requirements may include other information, such as indications of a template to use in generating a label, text strings to populate fields in the label, language for which labels are to be generated and/or any other suitable information that may be later used to produce labels.

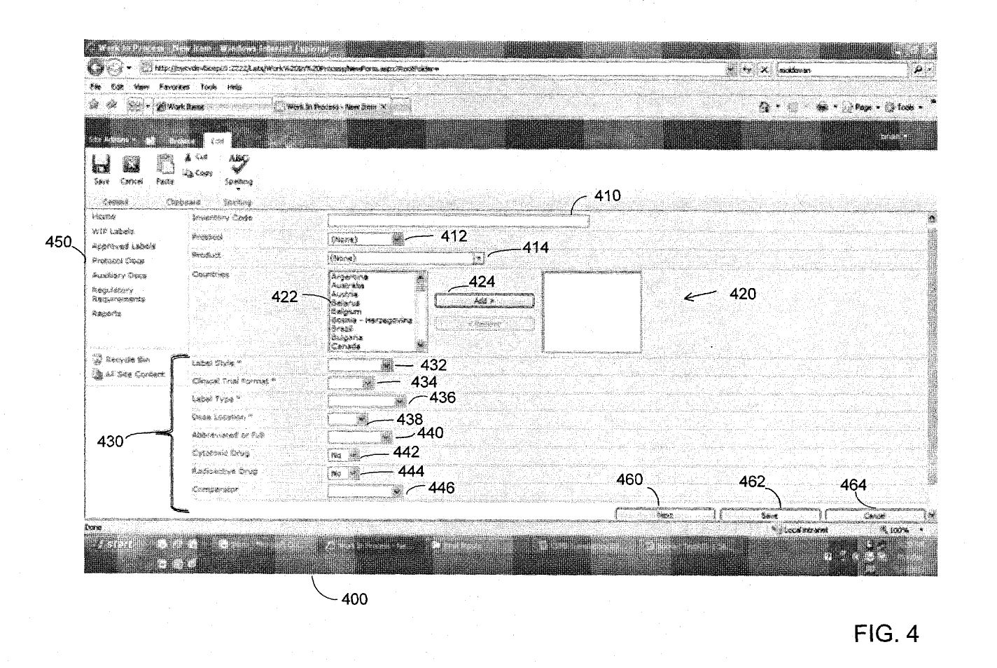

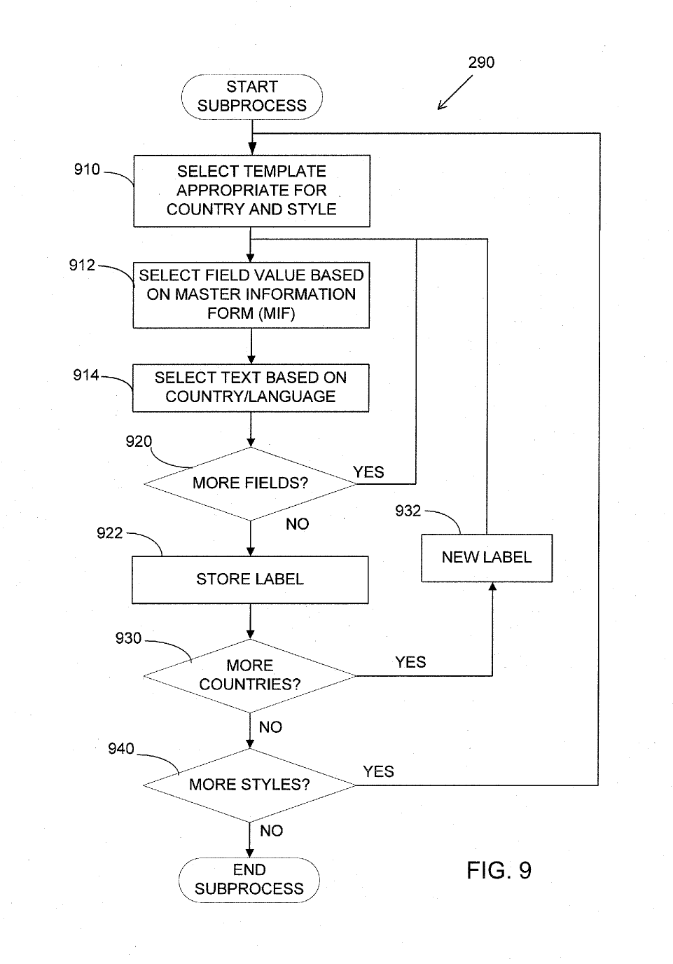

An exemplary sub-process 290 is illustrated in FIG. 9, below. However, before describing the sub-process of generating a label, exemplary mechanisms for obtaining user input and determining label content are provided. FIG. 4 illustrates a user interface 400 that may be rendered by a tool to obtain inputs, such as the inputs at subparts 220 and at block 230. In the example of FIG. 4, graphical user interface 400 is shown implemented using known graphical user interface construction techniques. Though, it should be appreciated that the user interface may be constructed in any suitable way. In this example, the user interface 400 is implemented with multiple input areas, some or all of which may be active objects, or other input elements, that when accessed by a user operating a computer mouse, keyboard or other computer input device, may accept inputs and trigger processing of those inputs.

In this example, input areas 410, 412 and 414 are adapted to receive input identifying the scenario for which one or more forms is to be generated. In this example, input element 410 is a text input field, into which a user may supply freeform text that will act as an inventory code. Any label generated using a template having a field for an inventory code will have the text entered through input area 410 appear in that field. Input elements 412 and 414 provide other information identifying the label to be generated. In this example, input element 412 receives input identifying a protocol and input element 414 receives input identifying a product. In this example, input elements 412 and 414 are implemented as drop down lists, meaning that they are configured to display an enumerated set of choices when activated by a user. However, any suitable mechanism may be used to obtain information about protocol, product or other parameter.

Display area 420 includes multiple controls through which a user may specify one or more regulatory domains for which labels are to be generated. Here the user interface includes a scroll box 422, which may be implemented as is known in the art. Scroll box 422 may be linked to a list of all of the countries, or other regulatory domains, for which the system is programmed to generate labels. The user may scroll through the choices presented in scroll box 422, interacting with the scroll box using techniques as are known in the art. The user may select one or more countries from the countries appearing in scroll box 422. By activating control 424 while a country is highlighted in scroll box 422, the user may provide input indicating that a specific country has been selected. Any suitable number of countries may be selected in this manner.

Region 430 contains further input areas that may be used to provide input defining values of label attributes. These label attributes may include any or all of the label attributes discussed above. Though, values for other label attributes may alternatively or additionally be obtained through input elements in region 430. In this example, input element 432 may be used to receive input indicating a value of a label style attribute. The tool, for example, may be configured to recognize different styles for cartons, vials, blister packs or other packaging that may be used. Input element 434 may be used to receive a value of a clinical trial format attribute. Input element 436 may be used to receive a value of a label type attribute. Input element 438 may be used to receive value of a dose location attribute. Input element 440 may be used to receive a value of a container size attribute. These attributes may be as described above.

In this example, the label attributes for which information is received within region 430 may be selected from a finite list of values recognized by the system. The values may be as described above and each of the input areas may be configured to present the limited number of possible values to the user for selection. In this example, each of the input elements 432, 434, 436, 438 and 440 is implemented as a drop down list using interface technology as is known in the art. When activated, each of the drop down lists may present a limited number of choices, reflecting the possible values of the specific attribute. The possible values may be determined based on the taxonomy of label types the system is configured to process. For example, input element 434, when activated, may present possible values for the clinical trial format attribute. When the system is programmed with a taxonomy such as taxonomy 300 (FIGS. 3A and 3B), the clinical trial format attribute may take on a value of “open” or “blinded.” Though, it should be appreciated that FIG. 4 is an example of only one possible embodiment and other user interfaces may be constructed to obtain any suitable information.

Other input elements may be included in region 430. For example, input elements 442, 444, and 446 are illustrated. These input elements may be used to obtain values of other attributes that may impact information appearing on a label. For example, through input element 442, a user may specify whether a label is being generated for a cytotoxic drug. Through input element 444, a user may specify whether a label is being generated for a radioactive drug. In either such case, a special legend may be added to a label indicating that a drug is cytotoxic or radioactive.

User interface 400 may include other components, including components to select information or navigate to other user inputs. For example, a navigation pane 450 may be provided to allow a user to access other information. Through the navigation pane 450, for example, a user may access information previously recorded about a label generation project.

By accessing such information, default selections may be pre-populated in input elements based on values in the information accessed. Though, accessed information maybe used in any suitable way. Control 462 may allow a user to save as part of an ongoing project defining a label the information input through graphical user interface 400. Conversely, control 464 may allow a user to cancel, without saving, the input.

Control 460 may move the user to a next step in the process of generating a label. In the example method 200, graphical user interface 400 may be used to supply inputs as are collected by the tool at blocks 210, 212, subpart 220 and block 230. Accordingly, selecting control 460 may cause the tool to determine a number of labels to be generated and construct a master information form for those labels. Additionally, the tool may render a user interface to prompt a user to enter values to appear in each of the fields when text for a label is generated.

FIG. 5 illustrates a data structure that may be used by the tool in this processing. In the example of FIG. 5, the data structure is configured as a spreadsheet. A spreadsheet may be implemented using technology as is known in the art. In this example, the spreadsheet contains multiple worksheets, each corresponding to a regulatory domain. FIG. 5 illustrates a spreadsheet 500 for which a single worksheet is visible. In this scenario, the worksheet 510 providing label requirements for the specific country Greece is illustrated. FIG. 5 illustrates that other countries have corresponding worksheets in spreadsheet 500.

The layout of each worksheet, providing the label requirements for a regulatory domain, may be the same. In this example, each of the worksheets has a column corresponding to a terminal node in the hierarchy 300 (FIGS. 3A and 3B). As described above, each terminal node in the hierarchy corresponds to a label type for which there may be a set of label requirements. In this example, the label requirements are expressed as fields to appear in a label.

Spreadsheet 500 is organized with multiple rows. In this example, each of the rows, such as rows 514₅, 514₆ . . . 514₁₅ corresponds to a field type. Data in the cells of spreadsheet 500 indicates whether a particular field type is to appear on a particular label type. A value entered in a cell of the spreadsheet at the intersection of the corresponding row and column indicates whether a field type, corresponding to the row is to appear on a label of the type corresponding to the column. For example, column 512B corresponds to a secondary label to be generated for a drug for home administration in an open clinical trial. Row 514₅ corresponds to a field containing a product name. Cell 530 is at the intersection of row 514₅ and column 512B. In the scenario illustrated in FIG. 5, cell 530 contains an “X,” indicating that the product name field represented by row 514₅ should appear on a secondary label generated for home administration of an open protocol clinical trial represented by column 512B.

Conversely, cell 532 which is at the intersection of row 5145 and column 512H, is empty. In this example, the empty cell 532 indicates that a product name field corresponding to row 514₅ does not appear on a label of the type having attributes corresponding to column 512H. In this example, column 512H corresponds to a secondary label generated for home administration during a blinded protocol.

FIG. 5 illustrates a subset of the possible fields about which spreadsheet 500 may be configured to provide information. Nonetheless, FIG. 5 illustrates a mechanism by which a tool may determine, based on specified values for label attributes, label requirements. As a specific example, a tool may select an appropriate column in spreadsheet 500 corresponding to a specified combination of values for label attributes that have been specified for a label being generated. The rows corresponding to cells in that column marked for inclusion indicate the fields to be included in the label requirements. Fields identified in this way may be added to the master information form or otherwise recorded for use in generating a label.

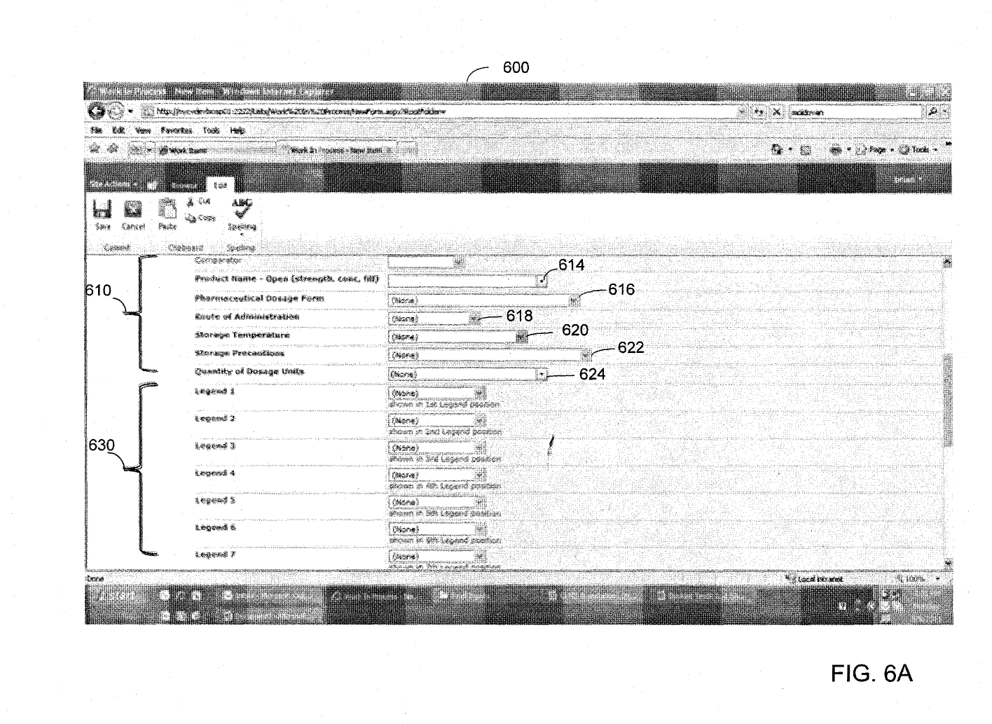

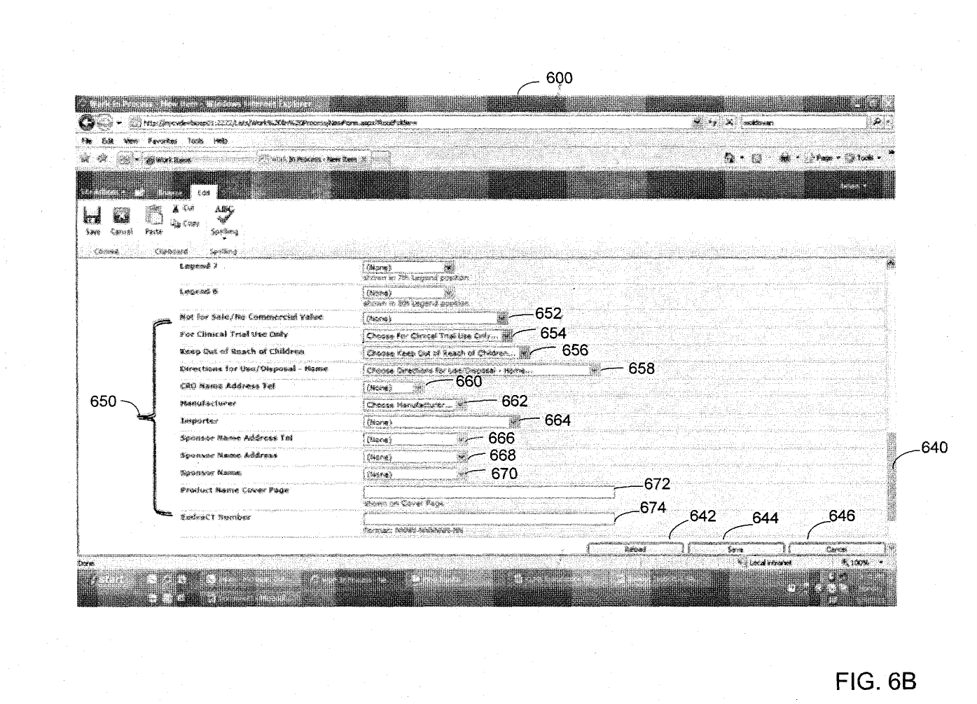

In the example method 200 of FIG. 2, once the master information form is constructed at block 242, information from the master information form is used to render a user interface through which a user may be prompted to enter values of text to appear in the selected fields. FIGS. 6A and 6B illustrate a user interface 600 through which such information may be obtained. In this example, user interface 600 includes a region 610 rendered based on the fields identified in the master information form to appear in a label being generated. For example, input element 614 may be configured to receive a value representing text to appear in a product name field. Input area 614 may appear on user interface 600 when the information stored in the master information form indicates that a product name is to appear on at least one label to be generated. Similarly, input element 616 is configured to receive a value representing text to appear in a field indicating pharmaceutical dosage form. Input element 618 may be configured to receive a value representing text to appear in a field presenting information about route of administration. Input element 620 may be configured to receive a value representing text to appear in a field presenting information about storage temperature. Input element 622 may be configured to receive a value representing text to appear in a field presenting information about storage precautions. Input element 624 may be configured to receive a value representing text to appear in a field presenting information about quantity of dosage units. Each of these input elements 614, 616, 618, 620, 622 and 624 may appear on graphical user interface 600 in response to a determination that the field for which a value is being solicited from a user will appear in at least one of the labels to be generated.

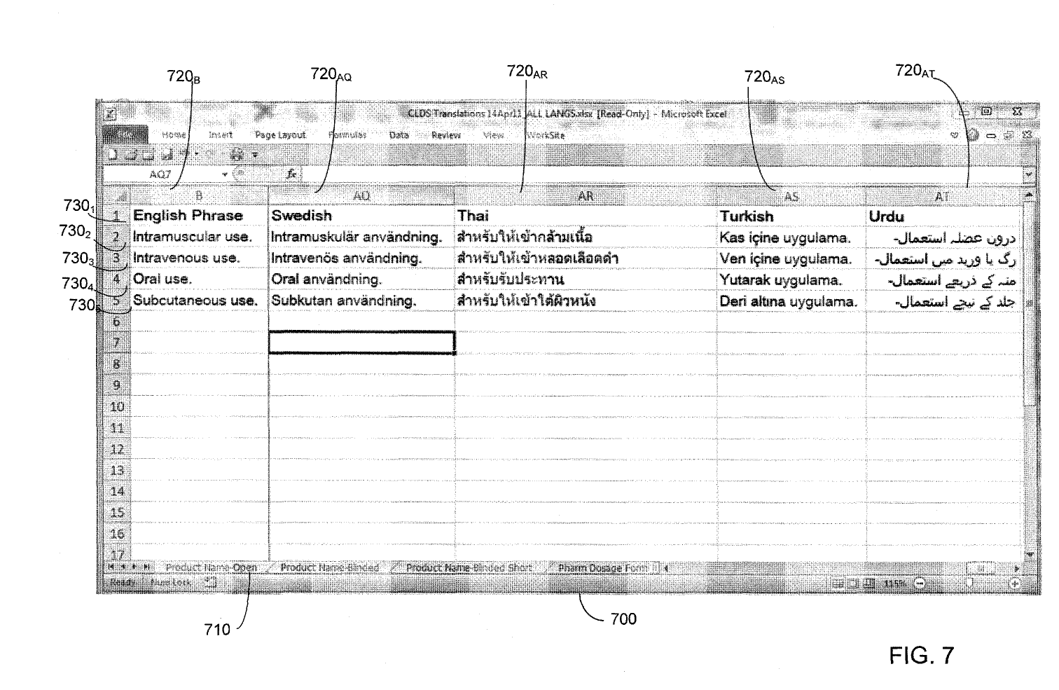

Input elements 614, 616, 618, 620, 622 and 624 may be implemented in any suitable way. In this example, though, each of the input elements is implemented as a drop down list using graphical user interface display technology as is known in the art. The values to appear in the lists associated with each of the input elements may be obtained in any suitable way. In the example of FIG. 1, a list of values for each field for which input is to be solicited may be obtained from a phrase library stored in data store 134. An example of a data structure that may exist in phrase library 134 is given in FIG. 7.

In the example of FIG. 7, a phrase library may be implemented as a spreadsheet 700. In the example of FIG. 7, spreadsheet 700 contains multiple worksheets. Each of the worksheets corresponds to a potential field that may appear in a label. For example, FIG. 7 shows a tab corresponding to a worksheet relating to a route of administration field. Tab 710 corresponds to the same field identified in row 514₉ of spreadsheet 500 (FIG. 5). FIG. 7 illustrates only a portion of the worksheets that may exist in spreadsheet 700. A separate worksheet may be provided for each possible field, as defined in spreadsheet 500 or in any other suitable way.

Each of the worksheets may have generally the same format. In this example, a worksheet contains multiple columns. A first column, illustrated at column 720_{B} in FIG. 7, contains phrases in the primary language of the system. Each of the phrases in column 720_{B} represents a possible value that may appear in the field corresponding to the worksheet. In this example, column 720_{E} displays a list of phrases that may appear in a particular field. In this example, the selected worksheet contains phrases that may be appropriate for a field providing information about route of administration. Accordingly, in row 730₂ . . . 730₅, spreadsheet 700 provides phrases such as “intramuscular use” . . . “subcutaneous use” that may appear in a field on a form indicating a method of administration. Accordingly, the values in column 720_{E} may be used to present a list of choices to a user. Returning to the example of FIG. 6A, the values in column 720_{B} may be used to generate a list for input element 618, associated with a route of administration field. Other worksheets in spreadsheet 700 may similarly provide values to populate lists for others of the fields in region 610.

Accordingly, using the information in spreadsheet 700, values to appear in lists associated with input elements in region 610 may be determined. Though, it should be appreciated that other types of input elements may be included in user interface 600. These input elements may similarly use drop down lists or may be in any suitable form, including free text input fields.

Regardless of the source from which values are obtained to offer a list of choices to a user, once a user makes a selection, that selection may be stored. In the illustrated embodiment, the selection may be stored in the master information form for subsequent use in generating label text. In the example illustrated, the options presented to the user and the information on the user selection is stored only in the primary language of the system. Though, it should be recognized that this information may be stored in any suitable format and that spreadsheet 700 (FIG. 7) allows labels to be generated in other languages based on this information.

As can be seen in FIG. 7, spreadsheet 700 contains multiple columns corresponding to column 720_{B}. Each column contains a corresponding phrase in a different language. For example, column 720_{AQ} contains the same phrases that appear in column 720_{B} in Swedish. Column 720_{AR} contains those same phrases in Thai. Column 720_{AS} contains the phrases in Turkish. Column 720_{AT} contains the same phrases in Urdu. Accordingly, when label text is to be generated in a language other than the primary language, the tool may consult spreadsheet 700 to obtain a text string to appear in each field for which a value was specified, even though the value was specified in English.

In addition to region 610, which is rendered based on the fields identified in the master information form, user interface 600 may include, for example, region 630 where other input about information to appear on a label may be provided, as illustrated in FIG. 6A. In this example, region 630 contains multiple input elements through which a user may specify text to appear in various legend fields that may be defined as part of a label template.

FIG. 6B illustrates a continuation of graphical user interface 600. User interface 600 is illustrated in a state entered into by a user activating scroll control 640 to reveal further input elements. Through the input elements revealed in FIG. 6B, a user may specify further information that may appear in label text generated by the tool. Here, a region 650 is illustrated containing multiple input elements through which a user may specify multiple types of information that may appear on a label. For example, through input element 652, a user may specify text to appear in a field on a label to indicate that the drug is not intended for sale. Similarly, input element 654 may allow a user to specify text to appear in a field on a label indicating that the drug is for clinical trial use only. Other input elements 656, 658, 660, 662, 664, 666, 668 and 670 may similarly allow a user to specify text to appear in other fields on a label. These fields may, for example, be used to indicate that the label should contain a “keep out of reach of children” warning, directions for use or disposal, contact information for a clinical research associate, a manufacturer, an importer or a clinical trial sponsor. In the illustrated example, input elements 652, 654, 656, 658, 660, 662, 664, 666, 668 and 670 are implemented as drop down list elements similar to those described above in connection with FIG. 6A. Though, it is not a requirement that each of the input elements be implemented as a drop down list. For example, FIG. 6B shows free text input elements 672 and 674. These input elements may be used to receive text to appear in fields relating to a product name or number.

In some embodiments, the input elements appearing in FIG. 6B, like the input elements appearing in FIG. 6A, may be dynamically selected by the tool based on determined requirements for a label or the aggregated requirements for a set of labels to be generated. Though, it is not a requirement that the fields in the user interface be generated in this way. Some or all of the input elements may appear by default. Values entered through these input elements, for example, may be inserted in a field in a label in response to user input being supplied through graphical user interface 600. Though, it should be appreciated that the specific mechanism by which fields are indicated to appear on a label is not critical to the invention, and any suitable mechanism or combination of mechanisms may be used.

FIG. 6B illustrates other elements that may be included in graphical user interface 600. In this example, graphical user interface 600 may include controls that manage the storage and retrieval of information appearing in graphical user interface 600. For example, control 644 may be activated by a user to save information entered through interface 600. Information may be saved as part of a project such as may be created at block 212 of method 200 (FIG. 2). The information saved may represent selections made or inputs provided through each of the input elements in graphical user interface 600. Alternatively, by activation of control 646, the user may cancel without saving, any inputs provided.

Control 642 may be accessed by a user to reload previously saved values. In the embodiment illustrated in FIG. 6, each of the input elements may display a user selection or input. By using control 642 to reload values, a user may configure user interface 600 to show in each of the input elements, a corresponding selection or input previously provided by a user. The reload control 642, for example, may be activated by a user to restart work on a project or to load information previously specified for a label such that the information may be updated.

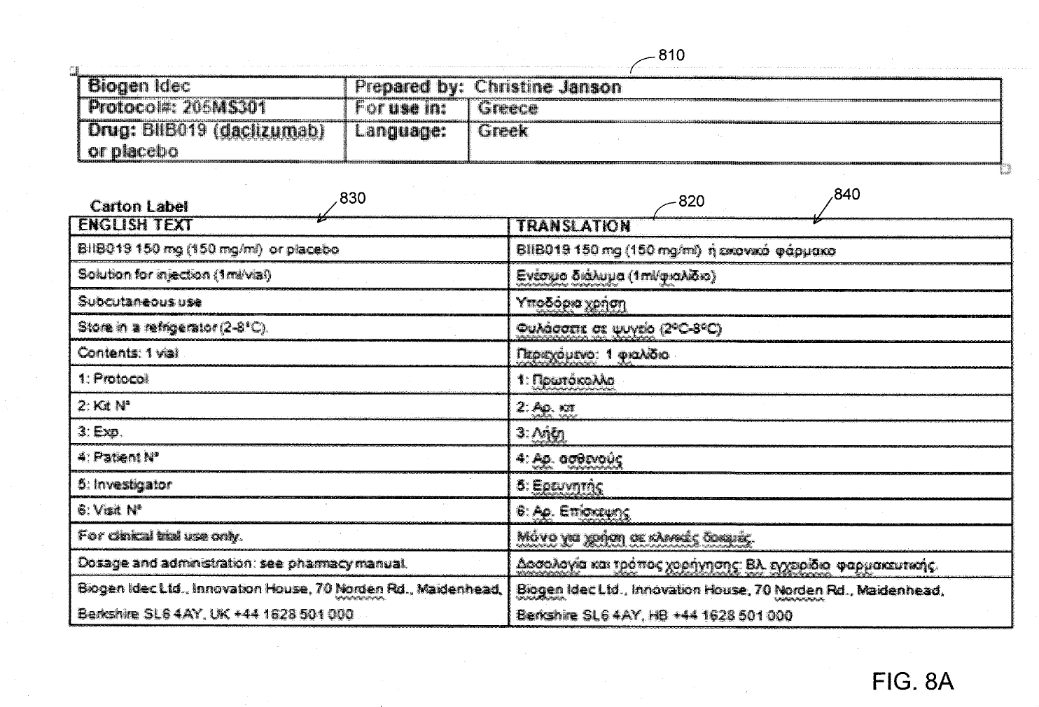

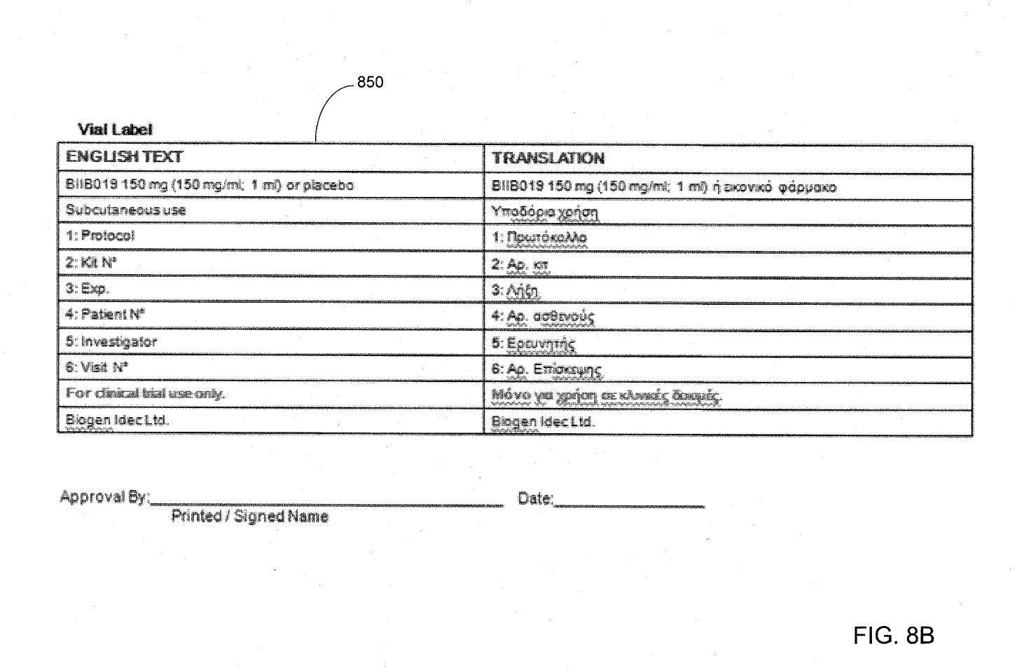

Regardless of the specific mechanism by which inputs are provided, these inputs may be used to generate label text. FIGS. 8A and 8B provide examples of label text that may be generated. In this example, some of the fields contain dummy text for simplicity of illustration. Accordingly, it should be appreciated that FIGS. 8A and 8B illustrate the format of a label, and that labels actually generated may have text other than as illustrated.

Other information may be printed along with labels. In this example, the printed information includes a header 810 that might provide information about scenarios in which the label 820 is to be used. The header may be printed with a label, but may not be affixed to a package containing the drug. The information in header 810 may, like information appearing in label 820, be input by a user or obtained in any other suitable way.

Labels may be generated in one or more styles, and labels in different styles generated as a part of a single project may be printed together or separately. In FIG. 8A, label 820 is formatted for use as a carton label. The format may be determined based on user input. For example, user input through input element 432 indicating a label style may specify that the label should be formatted as a carton label. The specific format of a carton label may be determined based on a text template selected from data store 132. The text template alternatively or additionally may be selected based on values of other label characteristics specified through region 430 (FIG. 4) or in any other suitable way.

The template may be used to arrange fields in a label. The specific fields appearing in the label may be determined based on the values for the label characteristics specified by user input and information such as may be found in spreadsheet 500 (FIG. 5). The specific text appearing in those fields may be determined based on user input received through user interface 600 (FIGS. 6A and 6B).

In the example of FIG. 8A, label 820 includes two panels. Panel 830 contains a label with information in English. Panel 840 contains a label with the same information translated to Greek. The number of panels, and the specific language of each, also may be based on inputs received, such as through input elements in display area 420 (FIG. 4). Regardless of how the fields are formatted, once they are identified, the fields may be populated with text strings. The specific text for these strings may be acquired from spreadsheet 700 (FIG. 7) or other suitable data store.

FIG. 8B illustrates another example of a label 850. In this example, label 850 is formatted for attaching to a vial. Label 850 may be generated, for example, based input provided through input element 432 indicating that a vial label style is desired. In this example, label 850 contains different fields than label 820. Label 850 may be generated by a different template than label 820. Nonetheless, labels 850 and 820 may be generated using the same tool. Further, for any fields of the same type in both labels 820 and 850, the same text strings may be inserted in fields of the same type in both labels.

Turning to FIG. 9, a sub-process for generating label text is illustrated. Sub-process 290 may be executed following receipt of inputs as illustrated in FIG. 2. Though, the sub-process 290 may be implemented at any suitable time in response to user input or other suitable trigger event that may cause generation of label text.

In this example, sub-process 290 begins at block 910. At block 910, a template is selected. The template may be selected based on country, label style or other input parameters specified for the label to be generated.

At block 912, a field to be included in the label is identified. Processing at block 912 may entail accessing information stored in the master information form. Though, any suitable store of information may be used to determine which fields to include in a label being generated.

Processing may then proceed to block 914 where text is selected to populate the field selected at block 912. The text may be selected based on user input, which also may be captured in the master information form. In some embodiments, the master information form may store text, or an identifier for a text string, for each field. The text or indication may be based on a text string in the primary language of the system or based on any other suitable data. A translation may be selected, such as through spreadsheet 700 (FIG. 7), based on the country or language for which the label is being generated. Though, regardless of the manner in which the specific text is obtained, it may be inserted into an appropriate location based on the template selected at block 910.

The process may then proceed to decision block 920. The process may loop back from decision block 920 to block 912 if further fields remain to be included in the label text. If so, a further field and a corresponding text value may be selected. Sub-process 290 may continue looping in this fashion until all fields are processed.

When all of the fields indicated for inclusion in the label being generated have been processed, processing may proceed to block 922. At block 922, the label text may be stored. In some embodiments, storing at block 922 may include storing the label text with the determined formatting in a label repository, such as data store 142 (FIG. 1). Though, it is not a requirement that the information be stored. In some embodiments, the generated label text may be printed after it is generated. Such a processing, for example, may allow checking for changes in requirements each time labels are printed.

Sub-process 290 may then proceed to decision block 930. At decision block 930, processing may branch depending on whether further countries have been selected. If so, the process may branch from decision block 930 to block 932. At block 932, a new label may be started. Though, labeling requirements for each country may be met in any suitable way, including by combining separate labels for each country into a booklet, with each label occupying a panel of the booklet. Though not illustrated in FIG. 9, all of the labels for a project may be aggregated for printing or other processing.

From block 932, processing may loop back to block 912 where a process of collecting text to appear in the new label is initiated. As with the initial label generated, processing may entail determining each field to be included in the label and selecting text in the appropriate language.

Processing may continue in this fashion until no further selected countries remain for processing. In that scenario, processing may proceed from decision block 930 to decision block 940. At decision block 940, the process may again branch, depending on whether more label styles remain to be processed. As indicated in FIGS. 8A and 8B, for example, multiple label styles may be generated. Labels may be generated, for example, for carton, vials, blister packs or other packaging formats used to deliver drugs. Each such packaging format may contain its own label, which may be in a style tailored to the specific packaging format. Accordingly, if more label styles remain to be generated, processing may loop back to block 910 where the process may be repeated for the next label style. Conversely, when no further label styles remains to be processed, sub-process 290 may end.

FIG. 9 illustrates a sub-process by which one or more labels may be generated containing fields that comply with regulatory requirements in one or more regulatory domains. From time to time, events may occur that change the required content of a label. Such an event, for example, may be a decision by a regulatory authority. Alternatively, the event may be change in a clinical trial protocol, a change in a policy of the drug company sponsoring the clinical trial or any other suitable event. In response to such a change in requirements, the data stores accessed by the tool may be updated to reflect the new requirements. For example, spreadsheets, such as spreadsheets 500 and 700 may be updated to reflect new requirements. Additionally, business rules such as may be in data store 130 may be updated. Once this information is updated, method 200 may be repeated, generating new labels based on the changed requirements.

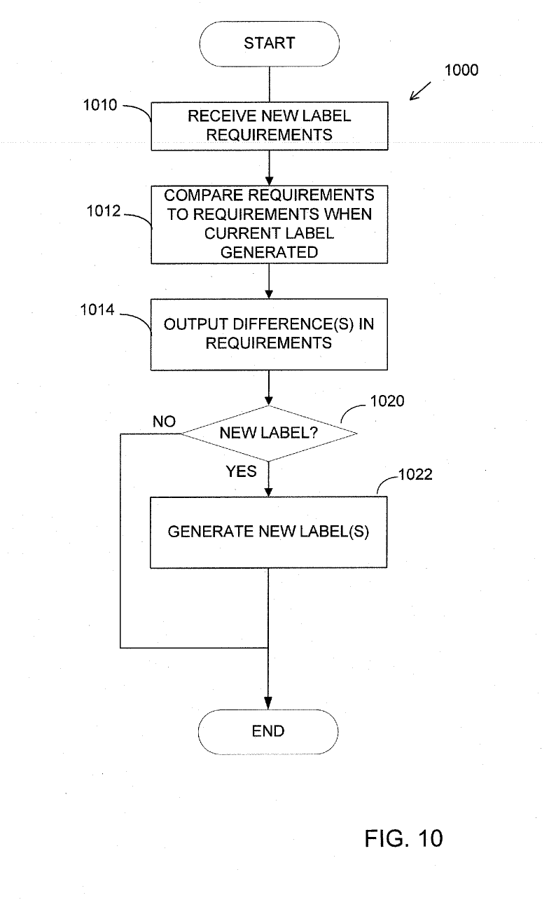

Though, in some embodiments, it may be desirable to determine the impact of a change in requirements before a new label is generated and/or deployed. Changing a label once in use may entail substantial administrative burden for the entities running the clinical trial. Accordingly, a tool as described herein may be adapted to aid a user assess the impact of a requirement change and allow the user to determine whether new labels are to be generated or existing labels can continue to be used. FIG. 10 illustrates a method 1000 that may be performed by such a tool.

The method 1000 may begin at block 1010. At block 1010, new label requirements may be obtained. The new label requirements may be obtained in any suitable way. Though, in some embodiments, the new label requirements may be obtained by creating a new version of the master information form using processing as is illustrated in FIG. 2.

At block 1012, the new requirements may be compared to requirements in place when the existing label was generated. Such a comparison may be made by comparing versions of the master information form or in any other suitable way. The comparison at block 1012 need not be based on text as generated for the label. Rather, it may be made at a higher level. For example, the comparison may be based on comparing fields as specified in the new version of the master information form relative to the fields as specified in the version of the master information form used to generate the existing label. A comparison at this higher level may aid a user in understand more quickly the impact of a change.

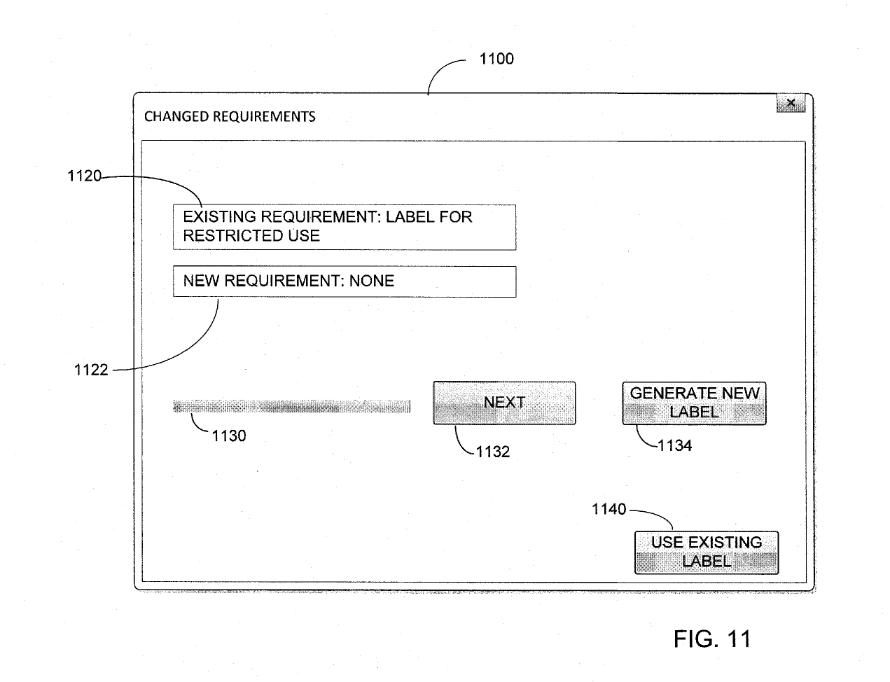

Processing may proceed to block 1014 where any identified differences in requirements may be output to a user. FIG. 11 illustrates an example of a user interface 1100 through which such changes in requirements may be output to a user. Such a user interface may be configured in any suitable way. In this example, the user interface 1100 is configured to present in step wise fashion each identified difference. Accordingly, graphical user interface 1100 is shown presenting information on a single identified difference.

In this example, user interface 1100 includes display area 1120 presenting information on a requirement as it existed at the time an existing label was generated. Display area 1122 presents information on the corresponding requirement as changed. In this example, display area 1120 indicates that, at the time the existing label was generated, there was a requirement to include on the label a legend indicating restricted use of the drug. Display area 1122 indicates that there is no corresponding requirement for such a restricted legend under the current requirements.

Such a side-by-side presentation of different requirements may allow a user to see that a requirement for a type of information has been added, deleted or otherwise modified. A user may view this information and assess the impact of the change. In the example of FIG. 11, a user may determine that there would be no impact to continuing use of the existing label even though it included a restrictive legend that is no longer required. Presenting the information in this fashion may enable a user to more readily identify an impact than by comparing text that might appear on a new versus existing label.

User interface 1100 includes controls that may allow a user to view each of the identified differences in turn. For example, upon analyzing a changed requirement, a user may activate control 1132 to trigger presentation of the next identified changed requirement. A progress bar 1130 or other mechanism may be included to signal to a user when all identified changed requirements have been viewed. Though, any suitable mechanism may be used to allow a user to view the cumulative effect of all changes.

If, upon reviewing all the changed requirements, a user determines that there is no impact to continuing with the existing label, the user may select control 1140 to end the process without generating a new label. Conversely, if upon reaching the end of all changes to review, or at any other time during the review of the changes, the user determines that a change would have a material impact on the label, the user may activate control 1134, which may cause a new label to be generated based on the new requirements.

Returning to FIG. 10, this process is illustrated at decision block 1020, where the process may branch depending on the user input. If the user indicates that no new label is required, the process branches to the end. Conversely, if the user indicates that a new label is required, the process may proceed to block 1022 where the new label is generated. Generating a new label may include, in addition to generating the text for the next label, printing new labels, distributing the labels and other actions, including possibly collecting and destroying existing labels which will no longer be used.

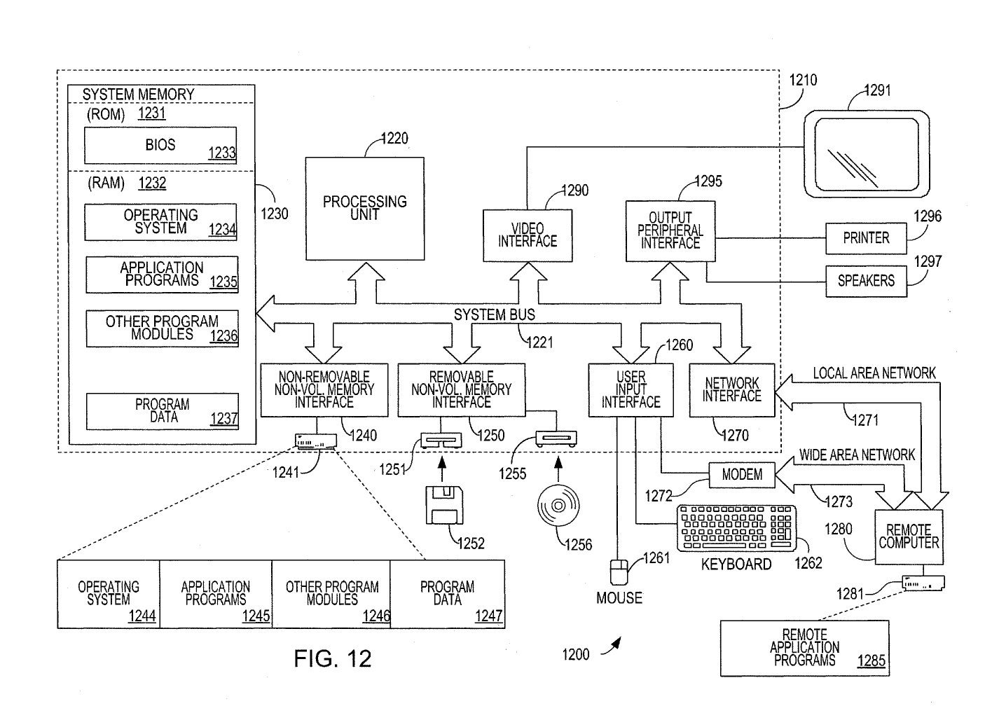

A tool as described herein may execute on any suitable computing system. FIG. 12 illustrates an example of a suitable computing system environment 1200 on which the invention may be implemented. The computing system environment 1200 is only one example of a suitable computing environment and is not intended to suggest any limitation as to the scope of use or functionality of the invention. Neither should the computing environment 1200 be interpreted as having any dependency or requirement relating to any one or combination of components illustrated in the exemplary operating environment 1200.

The invention is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The computing environment may execute computer-executable instructions, such as program modules. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 12, an exemplary system for implementing the invention includes a general purpose computing device in the form of a computer 1210. Components of computer 1210 may include, but are not limited to, a processing unit 1220, a system memory 1230, and a system bus 1221 that couples various system components including the system memory to the processing unit 1220. The system bus 1221 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 1210 typically includes a variety of computer readable media. Computer readable media can be any available media that can be accessed by computer 1210 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 1210. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 1230 includes computer storage media in the form of volatile and/or nonvolatile memory such as read only memory (ROM) 1231 and random access memory (RAM) 1232. A basic input/output system 1233 (BIOS), containing the basic routines that help to transfer information between elements within computer 1210, such as during start-up, is typically stored in ROM 1231. RAM 1232 typically contains data and/or program modules that are immediately accessible to and/or presently being operated on by processing unit 1220. By way of example, and not limitation, FIG. 12 illustrates operating system 1234, application programs 1235, other program modules 1236, and program data 1237.

The computer 1210 may also include other removable/non-removable, volatile/nonvolatile computer storage media. By way of example only, FIG. 12 illustrates a hard disk drive 1241 that reads from or writes to non-removable, nonvolatile magnetic media, a magnetic disk drive 1251 that reads from or writes to a removable, nonvolatile magnetic disk 1252, and an optical disk drive 1255 that reads from or writes to a removable, nonvolatile optical disk 1256 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 1241 is typically connected to the system bus 1221 through an non-removable memory interface such as interface 1240, and magnetic disk drive 1251 and optical disk drive 1255 are typically connected to the system bus 1221 by a removable memory interface, such as interface 1250.

The drives and their associated computer storage media discussed above and illustrated in FIG. 12, provide storage of computer readable instructions, data structures, program modules and other data for the computer 1210. In FIG. 12, for example, hard disk drive 1241 is illustrated as storing operating system 1244, application programs 1245, other program modules 1246, and program data 1247. Note that these components can either be the same as or different from operating system 1234, application programs 1235, other program modules 1236, and program data 1237. Operating system 1244, application programs 1245, other program modules 1246, and program data 1247 are given different numbers here to illustrate that, at a minimum, they are different copies. A user may enter commands and information into the computer 1210 through input devices such as a keyboard 1262 and pointing device 1261, commonly referred to as a mouse, trackball or touch pad. Other input devices (not shown) may include a microphone, joystick, game pad, satellite dish, scanner, or the like. These and other input devices are often connected to the processing unit 1220 through a user input interface 1260 that is coupled to the system bus, but may be connected by other interface and bus structures, such as a parallel port, game port or a universal serial bus (USB). A monitor 1291 or other type of display device is also connected to the system bus 1221 via an interface, such as a video interface 1290. In addition to the monitor, computers may also include other peripheral output devices such as speakers 1297 and printer 1296, which may be connected through a output peripheral interface 1295.

The computer 1210 may operate in a networked environment using logical connections to one or more remote computers, such as a remote computer 1280. The remote computer 1280 may be a personal computer, a server, a router, a network PC, a peer device or other common network node, and typically includes many or all of the elements described above relative to the computer 1210, although only a memory storage device 1281 has been illustrated in FIG. 12. The logical connections depicted in FIG. 12 include a local area network (LAN) 1271 and a wide area network (WAN) 1273, but may also include other networks. Such networking environments are commonplace in offices, enterprise-wide computer networks, intranets and the Internet.

When used in a LAN networking environment, the computer 1210 is connected to the LAN 1271 through a network interface or adapter 1270. When used in a WAN networking environment, the computer 1210 typically includes a modem 1272 or other means for establishing communications over the WAN 1273, such as the Internet. The modem 1272, which may be internal or external, may be connected to the system bus 1221 via the user input interface 1260, or other appropriate mechanism. In a networked environment, program modules depicted relative to the computer 1210, or portions thereof, may be stored in the remote memory storage device. By way of example, and not limitation, FIG. 12 illustrates remote application programs 1285 as residing on memory device 1281. It will be appreciated that the network connections shown are exemplary and other means of establishing a communications link between the computers may be used.

Having thus described several aspects of at least one embodiment of this invention, it is to be appreciated that various alterations, modifications, and improvements will readily occur to those skilled in the art.

For example, though embodiments are described in which fields present information as text, in other embodiments some or all of the fields may present information graphically or in any other suitable form.

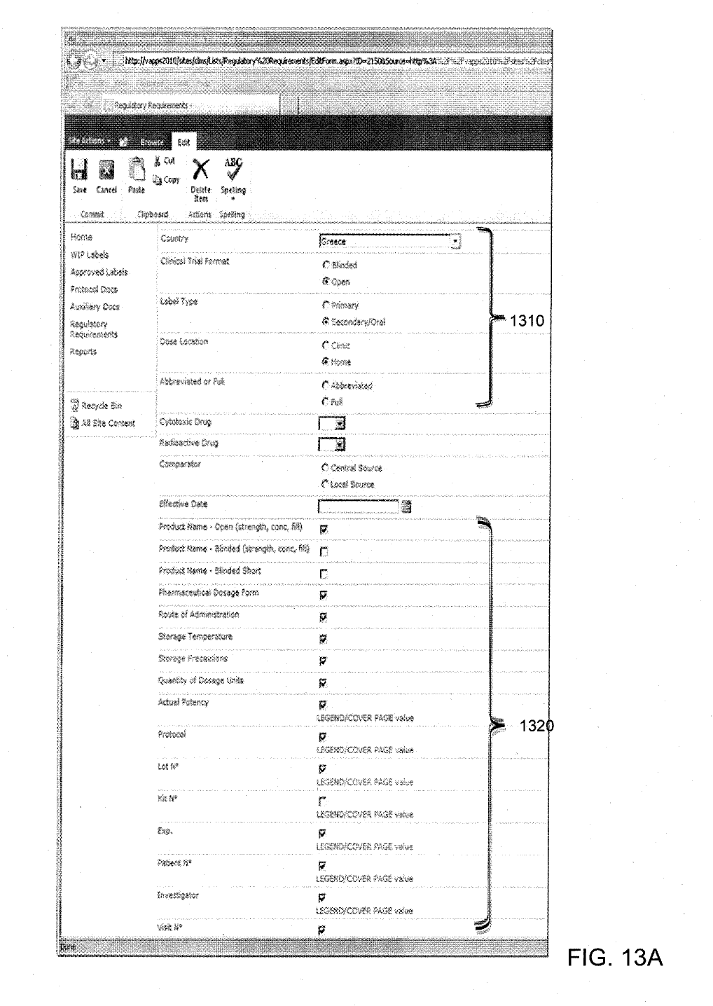

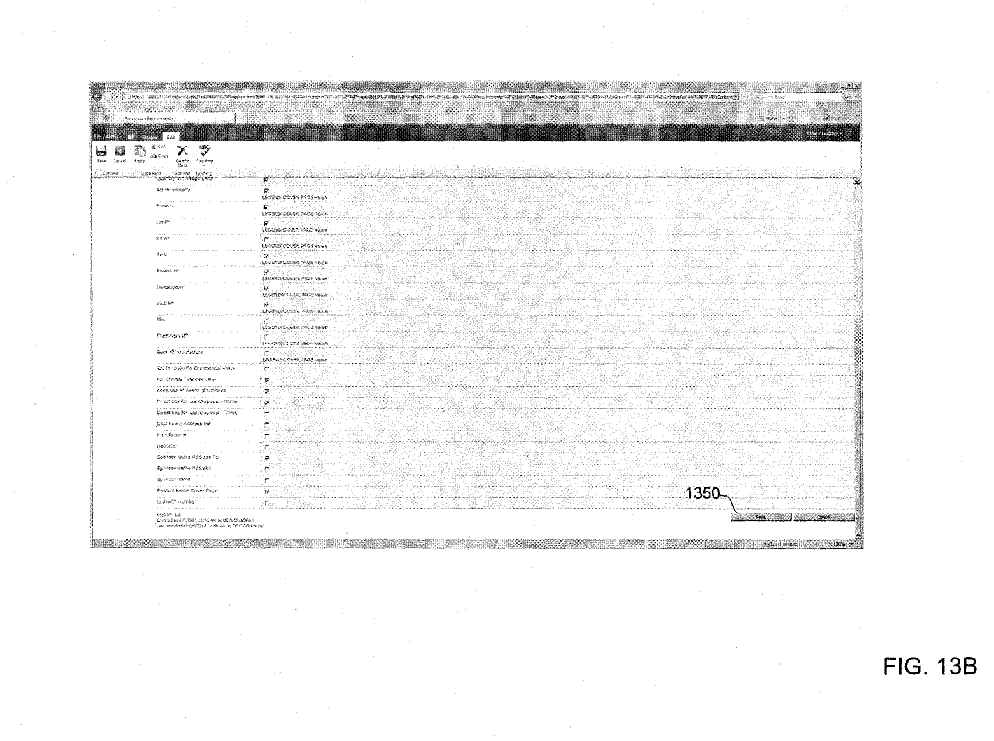

As a further example of a possible variation, FIG. 5 illustrates a representation of data that may be used to configure a label generation system. In FIG. 5, the data is illustrated as stored in a spreadsheet. In some embodiments, the system may be configured by an administrator or other individual or entity providing data formatted in a spreadsheet. However, in some embodiments, it may be desirable to provide a GUI through which an administrator or other entity may input or edit data configuring the system for a particular project. FIGS. 13A and 13B provide an example of such a GUI that may be accessed to provide configuration information for a project.

As another example of a possible variation, FIG. 8A illustrates an example of generated label text. The text strings included in the label of FIG. 8A may be acquired from spreadsheet 700 (FIG. 7) or other suitable data store. In some embodiments, generated label text may be presented to a user within a user interface that allows the user to edit the generated label text. In some embodiments, edits of the generated label text may be recorded in a change log stored in a suitable data store. Such a change log may be used to apply corresponding edits to a new label if a new label is generated (e.g., in order to comply with new regulatory requirements). In some embodiments, edits of generated label text that are entered via such a user interface may be stored as edits of the corresponding text strings in a phrase library, such as the phrase library illustrated in FIG. 7.

Any suitable mechanism may be used to specify label requirements to be stored as a way to configure the system. In this example, display area 1310 contains input elements through which a user may specify a country or other regulatory domain about which data is being supplied through the GUI. In this example, the country may be specified through a selection from a drop down list. In this example, the GUI may be configured to limit choices to only regulatory domains supported by the system.

The input elements in display area 1310 may also allow the user to specify a label type. In this example, the label type is specified by specifying values for a combination of attributes, as described above. Here, too, the input elements are of a type that constrain inputs to attributes and attribute values recognized by the system. For example, radio button type controls, as are known in the art of GUI design, are used for this purpose in the example of FIG. 13A.

Other portions of the interface, such as display area 1320, may include further input elements through which an administrator or other entity may specify label requirements. Here, the label requirements are specified in terms of fields to appear in the label. In this specific example, the input elements are check boxes, as are known in the art of GUI design. A check box may be provide for each type of label field the system has been programmed to recognize. An administrator may specify which types of label field will appear on a label having characteristics as indicated by selections made in display area 1310 through the check boxes.

FIG. 13B shows a continuation of input elements through which an administrator may indicate label field requirements. An administrator, for example, may scroll through the GUI, selecting fields. When all inputs are provided, the administrator may select a control, such as control 1350 to save the data, which may then be saved in a spreadsheet as illustrated in FIG. 5, or in any other suitable way.

Such alterations, modifications, and improvements are intended to be part of this disclosure, and are intended to be within the spirit and scope of the invention. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component. Though, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the present invention as discussed above. As used herein, the term “computer-readable storage medium” encompasses only a computer-readable medium that can be considered to be a manufacture (i.e., article of manufacture) or a machine. Alternatively or additionally, the invention may be embodied as a computer readable medium other than a computer-readable storage medium, such as a propagating signal.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method of generating a label for a drug, the method comprising:
receiving first user inputs identifying values of a plurality of label attributes;
based on the values of the plurality of label attributes, determining a plurality of label fields;
rendering on a display device an interface based on the determined plurality of fields, the interface comprising a plurality of input areas, each of the input areas corresponding to a respective label field of the plurality of determined label fields;
receiving second user inputs through the plurality of input areas, each received second user input specifying a text string associated with a respective label field of the determined plurality of label fields; and
with at least one processor, generating label text based, at least in part, on the received second user input.

2. The method of claim 1, wherein determining the plurality of label fields comprises:
accessing a data store comprising data indicating a respective plurality of label fields for each of a plurality of sets of label attribute values.

3. The method of claim 2, wherein:
the method further comprises receiving third user input identifying a regulatory domain;
the data store comprises data for each of a plurality of regulatory domains; and
determining the plurality of label fields comprises selecting data, associated with the regulatory domain, indicating the plurality of label fields.

4. The method of claim 2, wherein:
the method further comprises receiving third user input identifying a plurality of regulatory domains;
the data store comprises data for each of the plurality of regulatory domains; and
determining the plurality of label fields comprises:
selecting data, associated with each of the plurality of regulatory domains, indicating a respective plurality of label fields; and
aggregating the indicated pluralities of label fields associated with the plurality of regulatory domains.

5. The method of claim 1, wherein:
rendering the interface comprises rendering, for each of at least a portion of the determined plurality of fields, an interface object adapted to receive a user selection from a specified set of values, each value representing a text string.

6. The method of claim 1, wherein the plurality of label attributes comprise at least two of:
a clinical trial format;
a label type;
a dosage location; and
a container size.

7. The method of claim 1, wherein:
the method further comprises:
receiving third user input identifying a plurality of regulatory domains;
determining, based on predefined rules, a number of labels with which to present label information for the plurality of regulatory domains; and
generating label text comprises generating label text for the determined number of labels.

8. The method of claim 7, wherein:
generating label text further comprises:
generating label text for a plurality of panels, the plurality of panels comprising the determined number of labels, each panel being associated with at least one regulatory domain, the label text for each of the plurality of panels generated by accessing predetermined information indicating, for each text string associated with a second user input, a text string in a language applicable for the associated regulatory domain.

9. The method of claim 8, wherein:
generating label text further comprises, for each of the plurality of panels:
selecting a template from a predetermined set of label templates; and
arranging text strings in the applicable language in accordance with the selected template.

10. The method of claim 9, wherein:
generating label text comprises generating label text formatted as a booklet.

11. The method of claim 9, wherein:
generating label text comprises generating label text formatted as a secondary label.

12. At least one computer-readable storage medium comprising computer-executable instructions, that, when executed by a computing system, perform a method of generating a label for a drug, the method comprising:
receiving first user input indicating values of a plurality of label attributes;
receiving second user input indicating a plurality of regulatory domains;
determining a set of label fields representing an aggregation of label fields applicable in the plurality of regulatory domains, the set of label fields being determined based, at least in part, on the values of the plurality of label attributes;
generating a user interface adapted to receive a respective value for each label field in the set; and
generating label text based on values received through the user interface.

13. The at least one computer-readable storage medium of claim 12, wherein:
determining the set of label fields comprises constructing a master information form (MIF).

14. The at least one computer-readable storage medium of claim 12, wherein:
the method further comprises printing a label comprising the generated label text.

15. The at least one computer-readable storage medium of claim 12, wherein:
generating the user interface adapted to receive a respective value for each label field in the set comprises generating a user interface comprising a plurality of drop-down lists, each drop down list populated with a plurality of text strings representing a respective plurality of values for a respective label field in the set.

16. The at least one computer-readable storage medium of claim 15, wherein:
generating a label comprises generating label text by selecting, for each of at least a portion of the label fields in the set, a translated text string corresponding to the respective value, the translated text string representing the respective value in a different language, the different language being determined based on a regulatory domain of the plurality of regulatory domains.

17. The at least one computer-readable storage medium of claim 15, wherein:
receiving the user input identifying the plurality of label attributes comprises receiving user input through a user interface adapted to receive values for at least two of:
a clinical trial format;
a label type;
a dosage location; and
a container size.

18. The at least one computer-readable storage medium of claim 15, wherein:
the generated label is a first label generated in a first language, the first label comprising a first subset of the set of label fields; and
the method further comprises generating a second label in a second language, the second label comprising a second subset of the set of label fields, the second label comprising for each label field in the second subset a translated text string corresponding to the respective value, the translated text string representing the respective value in the second language, the second language being determined based on a regulatory domain of the plurality of regulatory domains.

19. The at least one computer-readable storage medium of claim 12, further comprising:
at least one data structure comprising one or more of:
a mapping between a plurality of combinations of attribute values and label fields applicable in each of a plurality of regulatory domains; or
a plurality of sets of text strings, each set of text string representing a value of a respective label field translated into a plurality of languages.

20. The at least one computer-readable storage medium of claim 19, further comprising:
a further data structure comprising a plurality of label templates, each template indicating a layout of fields.

21. A system to generate a label for a drug for a clinical trial protocol, comprising:
a user interface device;
a processor configured to:
receive user inputs identifying values of a plurality of label attributes;
based on the plurality of label attributes, determine a plurality of label fields;
render on the user interface device an interface based on the determined plurality of fields, the interface adapted to receive a plurality of values, each value corresponding to a respective label field of the plurality of label fields; and
generate label text based on the received plurality of values.

22. The system of claim 21, further comprising:
at least one computer-readable storage medium comprising at least one data structure comprising one or more of:
a plurality of label templates, each template indicating a layout of fields;
a mapping between a plurality of combinations of attribute values and label fields applicable in each of a plurality of regulatory domains; or
a plurality of sets of text strings, each set of text string representing a value of a respective label field translated into a plurality of languages.

23. The system of claim 22, wherein:
the processor is further adapted to:
receive second user inputs identifying a plurality of regulatory domains; and
generate a master information form (MIF) by determining a set of label fields representing an aggregation of label fields applicable in the plurality of regulatory domains, the set of label fields being determined based, at least in part, on the values of the plurality of label attributes

24. A computerized method of operating a labeling tool, the method comprising:
at a first time:
receiving user input identifying values of a plurality of label attributes;
based on the values of the plurality of label attributes and first stored information, determining a first plurality of label requirements;
generating a label based on the first plurality of label requirements; and
storing the first plurality of label requirements; and
at a second time:
determining a second plurality of label requirements based on the values of the plurality of label attributes and second stored information;
with at least one processor, comparing the first plurality of label requirements to the second first plurality of label requirements; and
presenting a user interface representing differences identified by the comparing.

25. The method of claim 24, wherein:
presenting the user interface comprises presenting a user interface adapted to receive user input indication whether to generate a new label meeting the second plurality of label requirements.

26. The method of claim 24, wherein:
the first plurality of requirements comprise a plurality of label fields for a regulatory domain for a label having attributes as defined by the values of the plurality of label attributes.

27. The method of claim 26, wherein:
the first plurality of requirements are represented as a first spreadsheet;
the second plurality of requirements are represented as a second spreadsheet; and
comparing the first plurality of label requirements to the second first plurality of label requirements comprises comparing the first spreadsheet to the second spreadsheet.
